(19) United States
(12) Patent Application Publication
(10) Pub. No.: US 2026/0336339 A1
(43) Pub. Date: Oct. 29, 2026

(54) Universal Stacked Tube Trailer Coupler

(71) Applicant: Gen-Y Creations, LLC, Nappanee, IN (US)

(72) Inventor: Carl J. Borkholder, Nappanee, IN (US)

(73) Assignee: Gen-Y Creations, LLC, Nappanee, IN (US)

(21) Appl. No.: 19/191,140

(22) Filed: Apr. 28, 2025

(51) Int. Cl. B60D 1/46; B60D 1/02; B60D 1/06; B60D 1/52

(52) U.S. Cl. CPC B60D 1/46; B60D 1/02; B60D 1/06; B60D 1/52

(57) ABSTRACT

A multi-receiver device is designed to be affixed to a trailer frame, either directly to the frame rails or to an existing channel mount. The multi-receiver device has a series of vertically-arranged receivers with some disposed above the top surface of the trailer frame and others disposed below. Each receiver can accept a removable coupler, such as a hitch ball coupler or lunette ring to make the trailer easily adaptable to different towing couplers that may be affixed to a towing vehicle. The removable coupler has a draw bar portion that allows secure attachment in any of the receivers. The vertical arrangement of the receivers allows the draw bar portion of the removable coupler to be attached to the trailer at different elevations relative to the trailer frame.

### BACKGROUND OF THE INVENTION

The present disclosure relates to “bumper pull” trailer couplers, where the trailer is coupled to a towing vehicle at the rear. Bumper pull trailer couplers are affixed or attached to the front of the trailer and are either a ball-and-socket or pintle connection. On ball-and-socket connections, the socket is located on the trailer and a ball is mounted to the vehicle. On pintle connections, the front of the trailer has a lunette ring that fits over a vehicle-mounted pintle hook that captures the ring. Some trailers have a vertically-oriented channel that is welded to the trailer frame, and the coupler (either socket or pintle style) is then attached to that channel using at least two transverse fasteners. The channel allows coupler accessories such as a ball socket or pintle to be mounted at different vertical heights to account for trailer or towing vehicle height differences, or even to be removed to prevent theft, but moving or removing ball socket or pintle requires the removal of the transverse fasteners. Further, with the coupler or lunette ring affixed using only two fasteners that are relatively close together, excessive tongue weight or dynamic forces between the trailer and towing vehicle could cause the transverse fasteners, channel, or coupler accessories to shear or tear out of the channel. In addition, if the trailer does not have the vertically-oriented channel, the user is stuck with the lunette ring or hitch ball coupler as it was originally affixed to the trailer frame. Therefore, an improved device is needed.

### SUMMARY OF THE INVENTION

The present disclosure describes a vertically adjustable coupler with a stacked tube assembly that is either welded to a trailer frame or can be retrofitted into an existing channel-mount trailer frame. The vertically adjustable coupler can be affixed to a trailer frame. The trailer frame has a first frame rail fixed with respect to a second frame rail, and the first and second frame rails have a top surface.

The weld mount vertically adjustable coupler includes an array of receivers fixed with respect to a mount portion. The array of receivers having a plurality of vertically-arranged receiver openings and corresponding lock pin apertures for each receiver opening. Each receiver opening can receive a removable coupler. The mount portion has a body plate that includes an end wall located between gusset walls. The array of receivers are affixed to the end wall. The mount portion is designed for being affixed to the first and second frame rails. When the mount portion is affixed to the first and second frame rails, at least one of the receiver openings is located above the top surface and another of the receiver openings is located below the top surface.

The channel mount retrofit vertically adjustable coupler has an array of receivers that is affixed to a tongue portion. The tongue portion is secured in the existing channel on the trailer.

Further, when the removable coupler is secured in one of the receiver openings, the coupling portion is a leading edge of the trailer frame. When the removable coupler is removed from the array of receiver openings, the receiver openings is the leading edge of the trailer frame.

The removable coupler has a coupling portion affixed to a shank portion. The coupling portion can either be a lunette ring or a ball coupler. The shank portion can be selectively received in one of the receiver openings and the coupling portion can couple the trailer frame to a towing vehicle. A removable lock pin can secure the removable coupler in one of the receiver openings by extending through the lock pin aperture and shank portion. The removable coupler is only secured within the receiver opening with the lock pin.

### BRIEF DESCRIPTION OF THE DRAWINGS

FIG. 1 is a front isometric view of channel mount prior art;

FIG. 2 is a front isometric view of a channel mount stacked tube receiver as affixed to a trailer;

FIG. 3 is a front isometric view of the channel mount stacked tube receiver in FIG. 2;

FIG. 4 is a front isometric view of a weld mount stacked tube receiver, flat steel receiver, and trailer frame;

FIG. 5 is a front isometric view of the weld mount stacked tube receiver in FIG. 4;

FIG. 6 is a side section view 6-6 of the stacked tube receiver in FIG. 5 with a coupler installed;

FIG. 7 is an isometric exploded view of the stacked tube receiver in FIG. 5;

FIG. 8 is a front isometric view of the weld mount flat steel stacked receiver in FIG. 4;

FIG. 9 is a side section view 9-9 of the flat steel stacked receiver in FIG. 8 with a lunette ring installed; and

FIG. 10 is an isometric exploded view of the flat steel stacked receiver in FIG. 8.

### DESCRIPTION OF THE PREFERRED EMBODIMENT

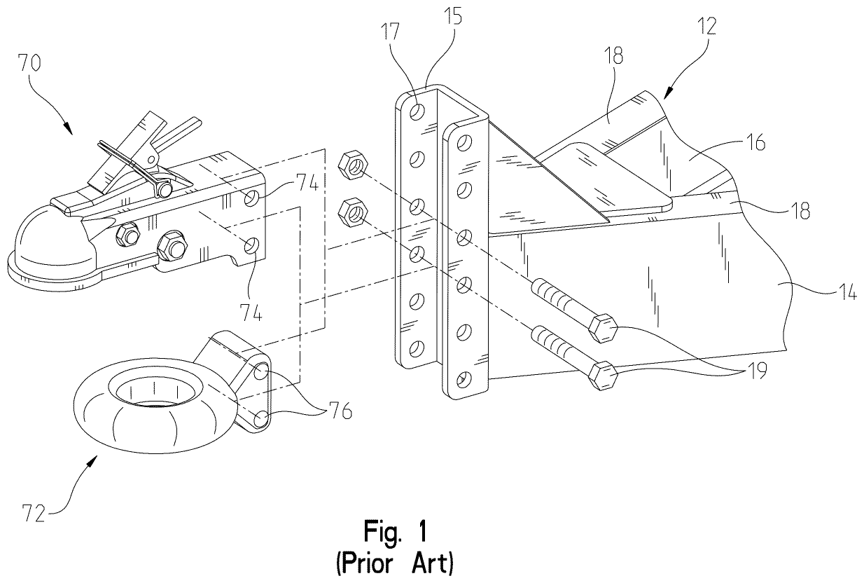

The prior art for vertically-adjustable trailer couplers is limited to a vertically-oriented channel 15 as shown in FIG. 1. The trailer frame 12 has a first frame rail 14 and second frame rail 16 that meet at the front where the vertical channel 15 is secured. The vertical channel 15 has a series of vertically-arranged apertures 17 that are spaced apart to receive fasteners 19. The vertical channel 15 is affixed to the trailer frame 12 with at least a portion being above a top surface 18 of the frame and another portion being below the top surface 18. The prior art couplers include a channel-mount ball coupler 70 and lunette ring 72, each having a channel portion with transverse apertures 74, 76. To adjust the vertical position of the prior art couplers 70, 72, the fasteners 19 must be removed, the coupler relocated to line up with different apertures 17, and the fasteners 19 reinstalled.

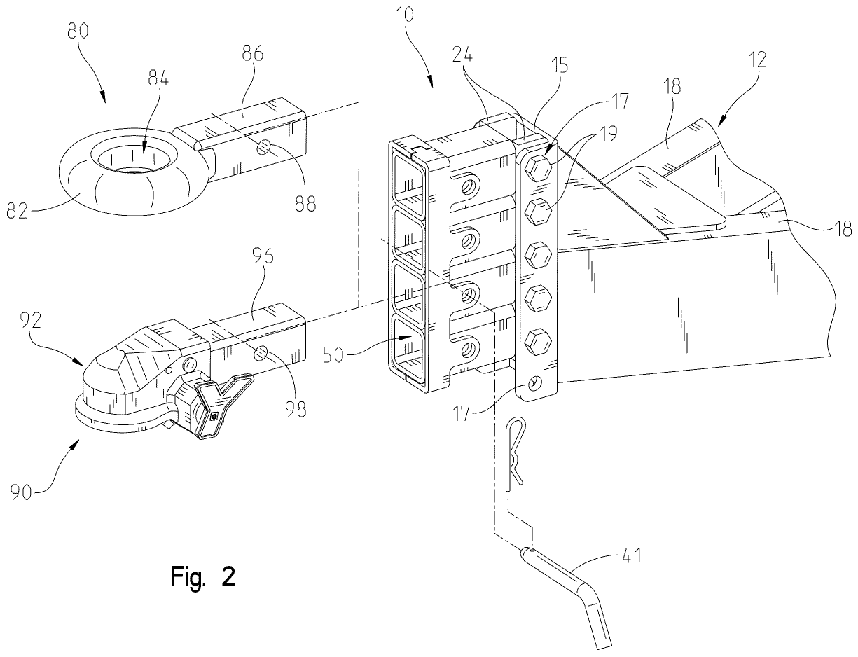

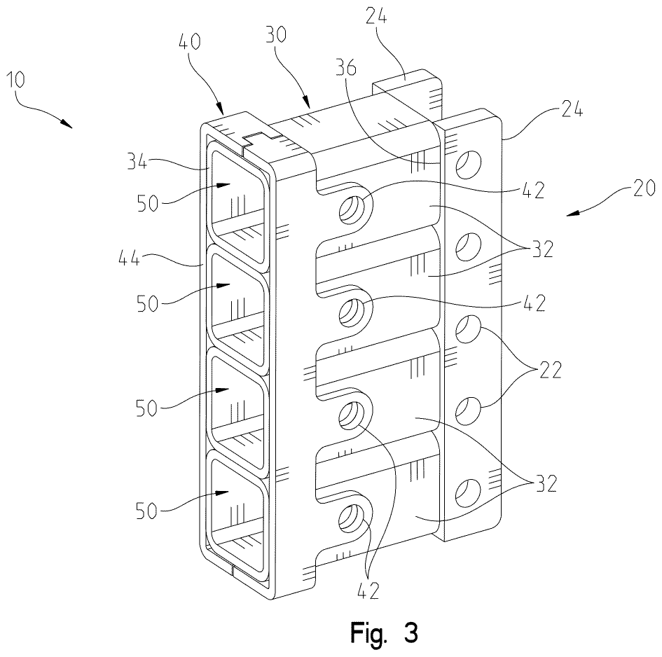

A channel mount stacked receiver 10 is shown in FIGS. 2-3 that can be affixed to the trailer frame 12 and incorporates an improved method of adjustment. The channel mount receiver 10 is designed to retrofit existing trailer frames 12 that already have the vertical channel 15. The channel mount receiver 10 has a tongue portion 20 with a series of vertically-arranged apertures 22 that align with the apertures in the channel 15 when the tongue portion 20 is received by the channel 15. The tongue portion 20 is formed from two parallel plates 24 but it is contemplated that the tongue portion is a single component. As can be seen in FIG. 3, the tongue portion 20 is affixed to a stack of tube receivers 30 that is formed from individual tube sections 32 that are cut to identical lengths and cut square on their ends. One end is an exterior end 34 and the opposite end is an interior end 36. The tube sections 32 are arranged in a straight line and affixed together, typically through welding. The tongue portion 20 is also affixed to the interior ends 36. The parallel plates 24 may be thick enough or positioned such that at least part of the tongue portion extends over the opening to at least partially close off the interior end. The exterior ends 34 are all aligned to be located on the same plane. Adjacent to the exterior ends 34 is a collar 40 that surrounds the stack of tube receivers 30. The leading edge of the collar 44 is coplanar with the exterior ends 34. Lock pin apertures 42 extend through the collar 40 and tube sections 32. To affix the channel mount receiver 10 to the vertical channel 15, the tongue portion 20 is placed in the vertical channel 15 and fasteners 19 are placed through the apertures 17 and apertures 22 and tightened. With the channel mount receiver 10 affixed to the trailer, a portion of the receiver openings 50 is located above the top surface 18 and a portion of the receiver openings 50 are located below the top surface 18. As affixed, the receiver openings 50 are substantially vertically arranged with respect to the trailer frame 12 and the leading edge or front face of the collar 44 and exterior end 34 of the receivers are located at the front edge of the trailer. For the purposes of this disclosure, “substantially” is defined as close to, nearly, mostly, but not requiring absolute precision. For example, substantially vertically could mean perpendicular to the trailer frame or as much as 10 degrees from vertical.

Each exterior end 34 surrounds a receiver opening 50 that can receive a removable coupling such as the lunette ring 80 or ball coupler 90 shown in FIG. 2. Once the removable coupling is inserted into the desired receiver opening 50, a lock pin 41 extends through the lock pin apertures 42 and removable coupling to secure it.

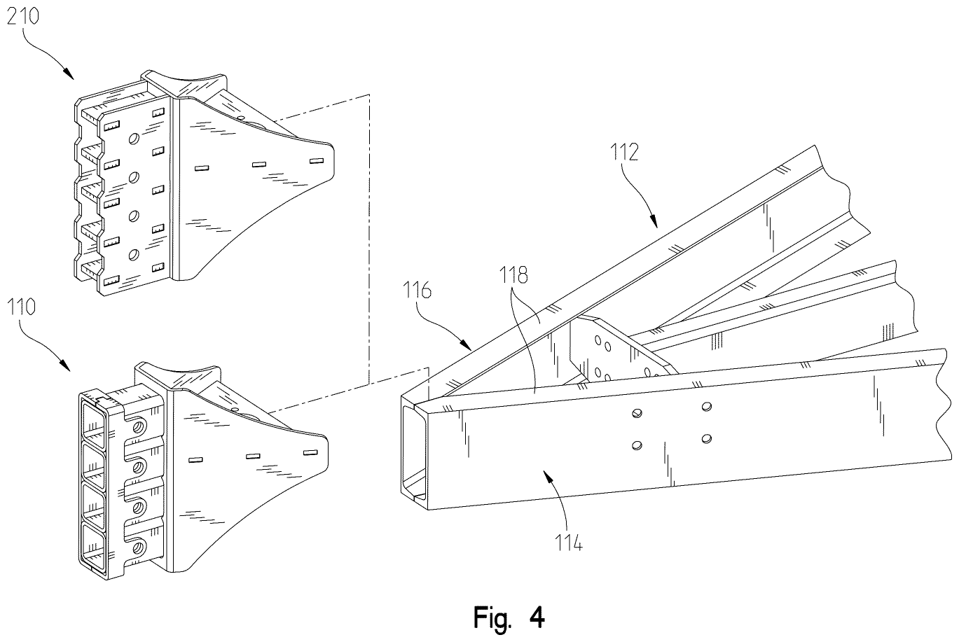

A weld mount tube receiver 110 and flat steel receiver 210 are shown in FIG. 4 as alternate embodiments to be affixed to a trailer frame 112. The trailer frame 112 has a first frame rail 114 and second frame rail 116 with a top surface 118. For the purposes of this disclosure, the top surface 118 of the frame rails 114, 116 is understood to be substantially horizontal when the trailer frame 112 is on a level surface. The frame rails 114, 116 meet at a front point of the trailer frame 112. Either receiver 110, 210 can be attached using fasteners, welding, or a combination of the two.

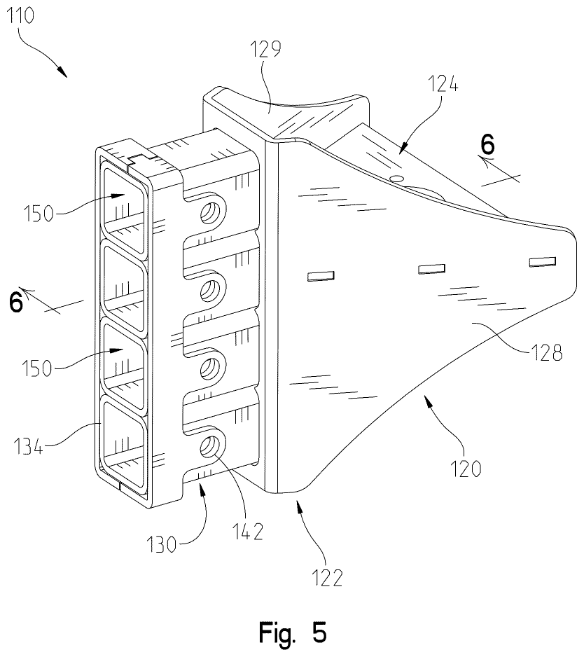

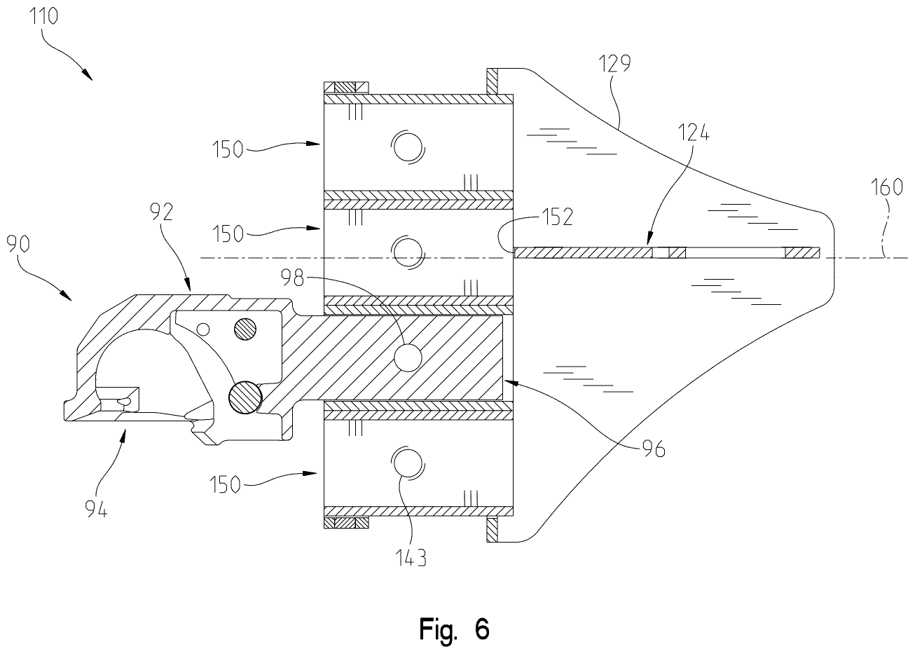

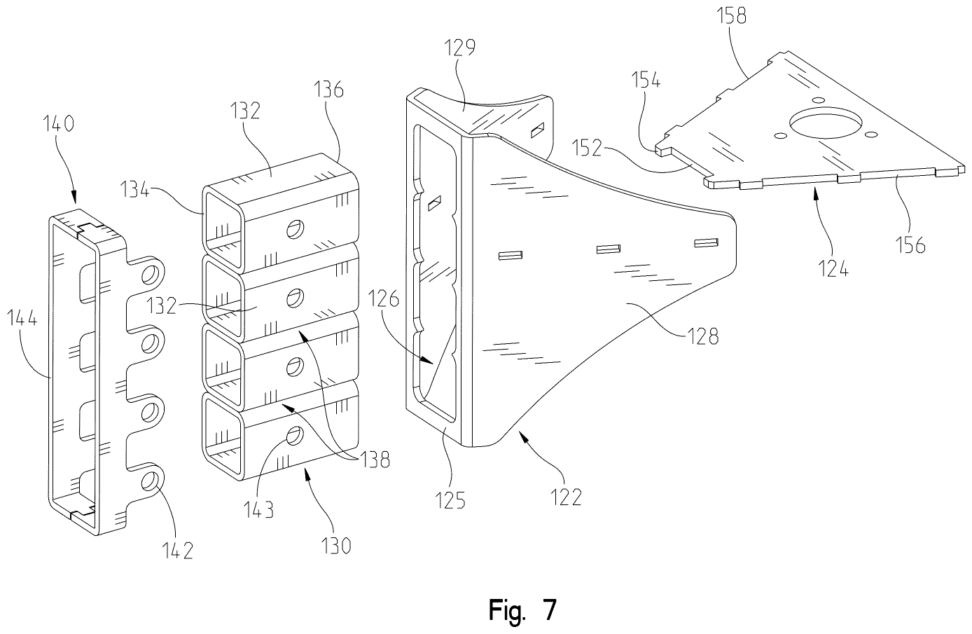

The weld mount tube receiver 110 is shown in FIGS. 5-7 and designed to be welded, riveted, or otherwise fastened to the trailer frame rails 114, 116 shown in FIG. 4. The tube receiver 110 includes a mount portion 120 attached to a stack of tube receivers 130. The stack of tube receivers 130 is formed from tube sections 132 (similar to tube sections 32) that are arranged in a straight line and affixed together. The tube sections 132 have lock pin apertures 143. One end of each tube section 132 is an exterior end 134 with the opposite end being an interior end 136. The individual tube sections 132 are square tubing with rounded exterior corners. When the tube sections 132 are stacked together, the rounded corners from adjacent tube sections form an outside profile that includes narrowed regions 138. Adjacent the exterior ends 134 is a collar 140 that surrounds the stack of tube receivers 130. The collar 140 has lock pin apertures 142 and is affixed with its leading edge 144 being coplanar with the exterior ends 134. Each exterior end 134 surrounds a receiver opening 150 that can receive a removable coupling such as the lunette ring 80 or ball coupler 90. Lock pin apertures 142, 143 extend through the collar 140 and tube sections 132. The mount portion 120 has a body plate 122 and a jack plate 124 that are affixed together, typically through welding or other fastening methods. The body plate 122 has an end wall 125 with a tube receiving aperture 126. The tube receiving aperture 126 has a profile that matches the outside profile shape of the stack of tube receivers 130, thereby allowing the stack of tube receivers 130 to be located in the tube receiving aperture 126. On either side of the end wall 125 are gusset walls 128, 129. The gusset walls 128, 129 are tallest nearest the end wall 125. The jack plate 124 is generally trapezoidal with a notch 152 on the narrow edge 154 and apertures for affixing a tongue jack (not shown). As is known in the art, a tongue jack has a foot that can be lowered to support the tongue/front end of the trailer when it is not coupled to a towing vehicle. The angled edges 156, 158 of the jack plate include tabs that are received by slots in the gusset walls. As can be seen in FIG. 6, the bottom surface of the jack plate defines a frame plane 160 that is aligned with the top surface 118 of the frame rails 114, 116 when the tube receiver 110 is attached to the trailer frame 112. Receiver openings 150 are located above and below the jack plate 124 and frame plane 160. In the embodiment shown herein, there are more receiver openings 150 located below the jack plate, but it is contemplated that there is an equal amount or more receiver openings above the jack plate. As affixed, the leading edge of the collar 144 and exterior end 134 of the receivers is the front edge of the trailer frame 112 and perpendicular to the top surface 118.

To build the tube receiver 110, tube sections 132 are cut to length. The rest of the components are cut from sheet metal. Cutting can be accomplished through laser, plasma, or water-jet cutting, stamping, or similar methods. The parts for the collar 140 are bent as needed to take their shape as shown in the FIGS. The body plate 122 is bent so that the gusset walls 128, 129 match the angled edges 156, 158. The tube sections 132 are aligned so the exterior ends 134 are coplanar. Next, the collar 140 is located so that the lock pin apertures 142 align to the lock pin apertures 143 and the parts may be welded together. Next, the body plate 122 and jack plate 124 are assembled with the notch 152 facing the tube receiving aperture 126. The stack of tube receivers 130 is inserted into the tube receiving aperture 126 enough for one of the interior ends 136 to contact the notch 152. The parts are then welded together. To affix the tube receiver 110 to the trailer frame 112, the tube receiver 110 is positioned with the bottom surface of the jack plate 124 in contact with the top surface 118 and frame rails 114, 116 adjacent or in contact with the gusset walls 128, 129. The tube receiver 110 is then welded, riveted, or otherwise fastened to the frame rails 114, 116, forming a rigid structure with the receiver openings 150 vertically arranged at the frontmost point of the trailer.

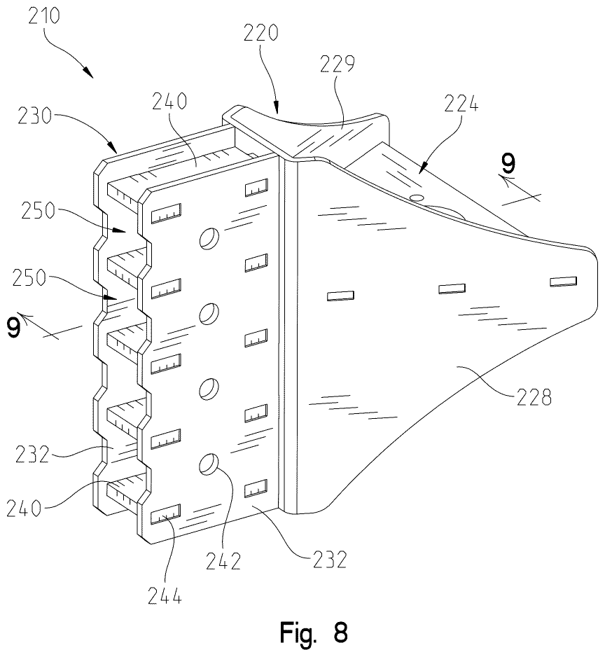

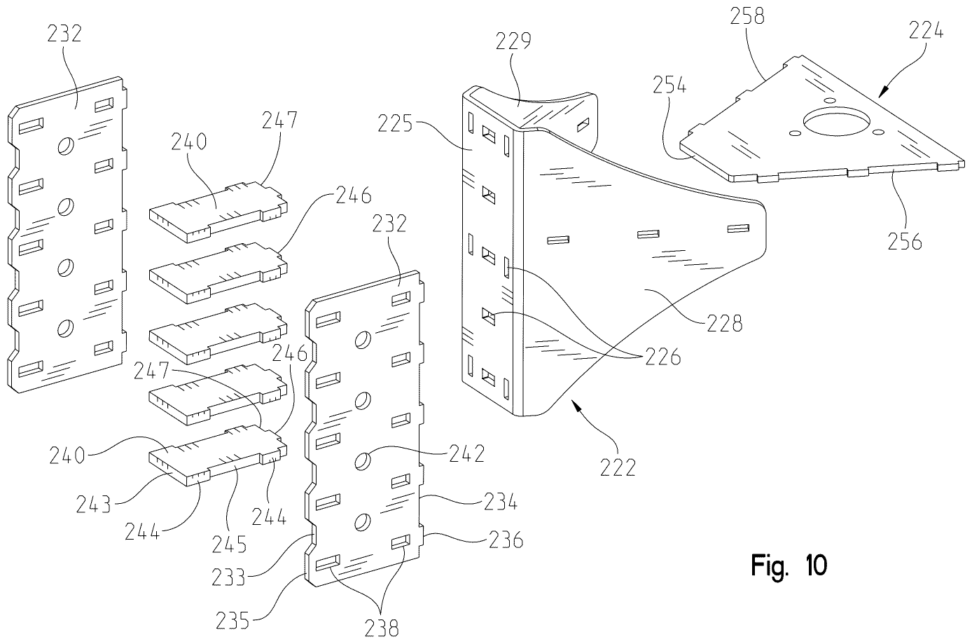

The weld mount flat steel receiver 210 shown in FIGS. 8-10 attaches to trailer frame rails 114, 116. The flat steel receiver 210 can be used with lunette ring 80 or ball coupler 90 (the same operation and attachment as weld mount tube receiver 110), but instead uses a different construction technique without the use of cut tubing. Instead, flat components are assembled to form receivers 250. The weld mount flat steel receiver 210 is formed from a series of plates that are cut from sheet metal and assembled together using a “tab and slot” design. The flat steel receiver 210 includes a mount portion 220 attached to an array of receivers 230. The array of receivers 230 is formed from multiple divider plates 240 and two identical side plates 232. The side plates 232 that have slots 238 and lock pin apertures 242 that extend completely through the thickness. The side plates also have a leading edge with recesses 233 located between protrusions 235. The side plates 232 include rear tabs 236 that protrude beyond a rear edge 234. The slots 238 are located between the protrusions 235 and rear tabs 236, while the recesses 233 are aligned with one edge of the slots 238. The identical divider plates 240 have a front edge 243 and an oppositely located interior edge 247 and tabs 244 that protrude from parallel sides 245. The tabs 244 mate with slots 238. The divider plates also include an end tab 246 that protrudes beyond the interior edge 247. As assembled, the interior edge 247 is coplanar with the rear edge 234 and the rear tabs 236 and end tab 246 terminate at the same distance from their respective edges. In addition, the front edges 243 are coplanar with the recesses 233.

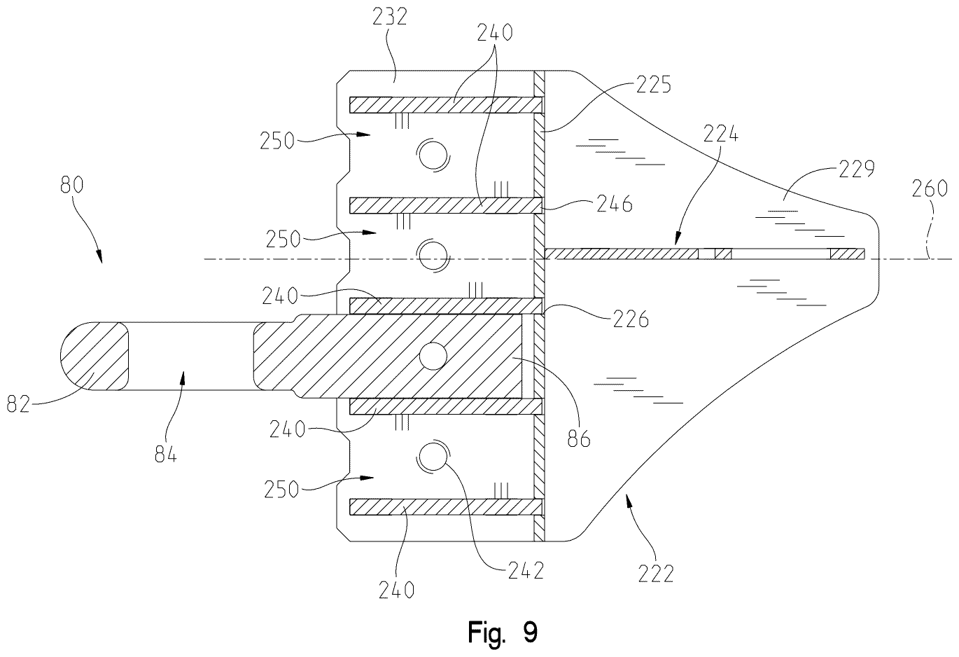

The mount portion 220 has a jack plate 224 and body plate 222. The body plate 222 has an end wall 225 that includes slots 226 that can receive the end tabs 246 and rear tabs 236. On either side of the end wall 225 are gusset walls 228, 229 that are tallest nearest where they meet the end wall 225. The jack plate 224 is generally trapezoidal with a narrow edge 254 that abuts the end wall 225 and apertures for affixing a tongue jack (not shown). The angled edges 256, 258 of the jack plate include tabs that are received by slots in the gusset walls. As can be seen in FIG. 9, the bottom surface of the jack plate defines a frame plane 260 that is aligned with the top surface 118 of the frame rails 114, 116 when installed. Receiver openings 250 are located above and below the jack plate 224 and frame plane 260. In the embodiment shown herein, there are more receiver openings 250 located below the jack plate, but it is contemplated that there is an equal amount or more receiver openings above the jack plate. As affixed, the protrusions 235 are the front edge of the trailer frame 112.

To build the flat steel receiver 210, the plates (side plates 232, divider plates 240, jack plate 224, and body plate 222) are cut from flat sheet metal. Cutting can be accomplished through laser, plasma, or water-jet cutting, stamping, or other equivalent methods. The body plate 222 is bent so that the gusset walls 228, 229 match the angled edges 256, 258. The jack plate 224 is then assembled to the body plate 222. The side plates 232 and divider plates 240 are assembled together and rear tabs 236 and end tabs 246 are mated to slots 226. The parts are then welded together to make these components into a rigid structure. It is contemplated that the components that make up the mount portion 220 and array of receivers 230 are separately welded and these two portions are then joined together and welded.

The jack plate 124, 224 and portions of the gusset walls that extend below the frame plane 160, 260 form a frame-mounting region where the frame rails 114, 116 are secured, typically through welding. It is contemplated that the frame rails 114, 116 are secured to the receiver 110, 210 through rivets, fasteners, or other techniques. As installed, at least one of the receiver openings 150, 250 is located above the frame plane 160, 260.

The pintle/lunette ring 80 is shown in FIGS. 2 and 9 with a lunette ring portion 82 surrounding a hook aperture 84. The ring portion 82 is affixed to a shank 86 with a transverse aperture 88. When the shank 86 is inserted into one of the receiver openings 50, 150, 250, the lock pin 41 can extend through lock pin aperture 42, 142, 242 and transverse aperture 88 to secure the lunette ring 80 to the trailer.

The ball coupler 90 is shown in FIGS. 2 and 6 with a coupler portion 92 having a hitch ball socket 94. The hitch ball socket 94 can receive a hitch ball (not shown) and move between an unlatched position and a latched position. In the unlatched position, the hitch ball can be received and removed by the hitch ball socket 94. In the latched position, the hitch ball is retained within the hitch ball socket 94. The coupler portion 92 is affixed to a shank 96 with a transverse aperture 98. As with the lunette ring 80, when the shank 96 is inserted into one of the receiver openings 50, 150, 250, the lock pin 41 can extend through the lock pin aperture 42, 142, 242 and transverse aperture 98 to secure the ball coupler 90 to the trailer. The lock pin 41 is the only component that secures the shank 86, 96 within the receiver opening. By removing the lock pin 41, the lunette ring 80 or ball coupler 90 can be removed and/or relocated to a different receiver opening. When the lunette ring 80 or ball coupler 90 is attached within the receiver opening, the lunette ring 80 or ball coupler 90 is the leading edge of the trailer. When removed, the receiver openings is the leading edge of the trailer.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A trailer frame having a vertically adjustable coupler, said trailer frame comprising:
a first frame rail fixed with respect to a second frame rail, said first and second frame rails having a top surface;
an array of receivers fixed with respect to said first and second frame rails, said array of receivers having a plurality of vertically-arranged receiver openings, said array of receivers having corresponding lock pin apertures for each of said receiver openings, at least one of said receiver openings is located above said top surface, another of said receiver openings is located below said top surface;
a removable coupler having a coupling portion affixed to a shank portion, said shank portion for being selectively received in one of said receiver openings, said coupling portion for coupling said trailer frame to a towing vehicle;
a removable lock pin for extending through said lock pin aperture;
when said shank portion is located in one of said receiver openings and said lock pin extends through said shank portion and said lock pin aperture, said removable coupler is only secured to said trailer frame with said lock pin; and
when said removable coupler is secured in one of said receiver openings, said coupling portion is a leading edge of said trailer frame, when all of said receiver openings are clear of said removable coupler, said array of receiver openings is said leading edge of said trailer frame.

2. The trailer frame of claim 1, further comprising a fixed channel affixed to said trailer frame, said array of receivers having a tongue portion affixed thereto, said tongue portion is received by and secured to said fixed channel.

3. The trailer frame of claim 1, wherein said coupling portion is a ball coupler, said ball coupler for connecting to a hitch ball.

4. The trailer frame of claim 1, wherein said coupling portion is a lunette ring, said lunette ring for connecting to a pintle coupler.

5. The trailer frame of claim 1, further comprising a mount portion having a body plate, said body plate includes an end wall located between gusset walls, said array of receivers is affixed to said end wall, said mount portion is affixed to said first and second frame rails.

6. The trailer frame of claim 5, further comprising a jack plate affixed to said body plate, said jack plate is trapezoidal and has a bottom surface coplanar with said top surface of said frame rails.

7. The trailer frame of claim 5, wherein said array of receivers is formed from tubing sections of equal length, each said tubing section having an exterior end and an oppositely located interior end, said lock pin aperture is located between said interior and exterior end, said tubing sections are affixed together with said exterior ends aligned.

8. The trailer frame of claim 7, further comprising a collar affixed to and circumscribing said array of receivers adjacent said exterior ends of said tubing sections, said collar having lock pin apertures aligned with said lock pin apertures in said tubing sections.

9. The trailer frame of claim 7, wherein said end wall has a tube receiving aperture complementary to an outside profile of said array of receivers, further comprising a jack plate affixed to said body plate, said jack plate is trapezoidal and having a bottom surface coplanar with said top surface of said frame rails, said jack plate includes a notch on a narrow edge, said array of receivers is affixed within said tube receiving aperture and one of said interior ends contacting said notch.

10. The trailer frame of claim 5, wherein said array of receivers has a pair of identical side plates and a plurality of identical divider plates, said side plates having slots to receive tabs located on said divider plates, said end wall has slots, said array of receivers includes rear tabs located in said slots in said end wall.

11. A vertically adjustable coupler device for being affixed to a trailer frame, said trailer frame having a fixed channel affixed thereto, said fixed channel having a plurality of apertures extending therethrough, said coupler device comprising:
a tongue for being received by said fixed channel, said tongue having a plurality of apertures extending therethrough, said apertures in said tongue being complementary to said apertures in said fixed channel;
a stack of receivers affixed to said tongue, said stack of receivers having a front face, each of said receivers having a receiver opening for receiving a removable coupler, said front face is parallel to said fixed channel when said device is affixed to said trailer frame; and
said removable coupler having a shank extending therefrom, said shank affixable within one of said receivers.

12. The vertically adjustable coupler of claim 11, wherein said removable coupler is a ball coupler affixed to said shank, said ball coupler for connecting to a hitch ball.

13. The vertically adjustable coupler of claim 11, wherein said removable coupler is a lunette ring affixed to said shank, said lunette ring for connecting to a pintle coupler.

14. A vertically adjustable coupler for being affixed to a trailer frame, said trailer frame having a first frame rail fixed with respect to a second frame rail, said first and second frame rails having a top surface, said vertically adjustable coupler comprising:
an array of receivers fixed with respect to a mount portion, said array of receivers having a plurality of vertically-arranged receiver openings, said array of receivers having corresponding lock pin apertures for each of said receiver openings;
said mount portion having a body plate, said body plate includes an end wall located between gusset walls, said array of receivers is affixed to said end wall, said mount portion for being affixed to said trailer frame;
a removable coupler having a coupling portion affixed to a shank portion, said shank portion for being selectively received in one of said receiver openings, said coupling portion for coupling said trailer frame to a towing vehicle;
a removable lock pin for extending through said lock pin aperture;
when said shank portion is located in one of said receiver openings and said lock pin extends through said shank portion, said removable coupler is only secured within said receiver opening with said lock pin; and
when said mount portion is affixed to said trailer frame, at least one of said receiver openings is located above said top surface, another of said receiver openings is located below said top surface, and when said removable coupler is secured in one of said receiver openings, said coupling portion is a leading edge of said trailer frame, when all of said receiver openings are clear of said removable coupler, said array of receiver openings is said leading edge of said trailer frame.

15. The vertically adjustable coupler of claim 14, wherein said coupling portion is a ball coupler, said ball coupler for connecting to a hitch ball.

16. The vertically adjustable coupler of claim 14, wherein said coupling portion is a lunette ring, said lunette ring for connecting to a pintle coupler.

17. The vertically adjustable coupler of claim 14, wherein said array of receivers is formed from tubing sections of equal length, each said tubing section having an exterior end and an oppositely located interior end, said lock pin aperture is located between said interior and exterior end, said tubing sections are affixed together with said exterior ends aligned.

18. The vertically adjustable coupler of claim 17, further comprising a collar affixed to said array of receivers adjacent said exterior ends of said tubing sections, said collar having lock pin apertures aligned with said lock pin apertures in said tubing sections.

19. The vertically adjustable coupler of claim 17, wherein said end wall has a tube receiving aperture complementary to an outside profile of said array of receivers, further comprising a jack plate affixed to said body plate, said jack plate is trapezoidal and having a bottom surface, said bottom surface is coplanar with said top surface of said frame rails when said mount portion is affixed to said trailer frame, said jack plate includes a notch on a narrow edge, said array of receivers is affixed within said tube receiving aperture and one of said interior ends contacting said notch.

20. The vertically adjustable coupler of claim 14, wherein said array of receivers has a pair of identical side plates and a plurality of identical divider plates, said side plates having slots to receive tabs located on said divider plates, said end wall has slots, said array of receivers includes rear tabs located in said slots in said end wall.
